(19) United States
(12) Patent Application Publication
(10) Pub. No.: US 2012/0251840 A1
(43) Pub. Date: Oct. 4, 2012

(54) NICKEL-BASE WELD MATERIALS, PROCESSES OF USING, AND COMPONENTS FORMED THEREWITH

(75) Inventors: Michael Patrick Maly, Cincinnati, OH (US); Thomas Joseph Kelly, South Lebanon, OH (US)

(73) Assignee: GENERAL ELECTRIC COMPANY, Schenectady, NY (US)

(21) Appl. No.: 13/075,339

(22) Filed: Mar. 30, 2011

(51) Int. Cl. C22C 19/05; B32B 15/01; B23K 31/02

(52) U.S. Cl. 428/680; 420/445; 228/101; 228/119

(57) ABSTRACT

Nickel-base alloys suitable for use as a weld material to weld high-temperature components (10), such as turbine blades and vanes of gas turbine engines. The nickel-base alloys consist essentially of, by weight, 5 to 10 percent chromium, 3 to 14 percent cobalt, up to 4 percent molybdenum, 3 to 7 percent tungsten, 5 to 9 percent tantalum, 5 to 8 percent aluminum, 0.1 to 2 percent hafnium, 0.005 to 0.03 percent boron, up to 0.15 percent carbon, the balance being nickel and incidental impurities and/or residual elements. Welds (12) formed with the alloys are capable of exhibiting desirable levels of strength and oxidation resistance, while containing little if any rhenium.

### BACKGROUND OF THE INVENTION

The present invention relates to materials and processes for welding components intended to operate at high temperatures. More particularly, this invention relates to nickel-base alloys that exhibit strength, weldability and resistance to oxidation and cracking that render the alloys suitable for use as a weld filler material in high temperature applications, for example, high pressure turbine components of gas turbine engines.

Components of gas turbine engines, such as blades (buckets), vanes (nozzles) and combustors, are typically formed of nickel, cobalt or iron-base superalloys with desirable mechanical properties for turbine operating temperatures and conditions. Notable examples are gamma prime (γ′) precipitation-strengthened nickel-base superalloys, particular examples of which include René 125, René 80, René N5, René N4, René 108, GTD-111™, GTD-444™, IN738, IN792, MAR-M200, MAR-M247, CMSX-3, CMSX-4, PWA1480, PWA1483, and PWA1484. Each of these alloys has a relatively high gamma prime (principally Ni₃(Al,Ti)) content as a result of containing significant amounts of aluminum and/or titanium. As the material requirements for gas turbine components have increased with higher operating temperatures, various processing methods have been used to enhance the mechanical, physical and environmental properties of components formed from superalloys. As an example, turbine blades and vanes and other components employed in demanding applications are often cast by unidirectional casting techniques to have directionally-solidified (DS) or single-crystal (SX) microstructures.

During the operation of a gas turbine engine, turbine components are subjected to various types of damage or deterioration, including wear and cracks. Because the cost of components formed from superalloys is relatively high, it is more desirable to repair these components than to replace them. For the same reason, new-make components that require repair due to manufacturing flaws are also preferably repaired instead of being scrapped. However, DS and SX castings formed of precipitation-strengthened nickel-base superalloys have proven to be particularly difficult to weld.

Methods for repairing nickel-base superalloys have included gas tungsten arc welding (GTAW) techniques (also known as tungsten inert gas (TIG) welding), laser welding, and plasma transferred arc (PTA) welding processes, which can be performed at room and elevated temperatures. In addition, welding processes referred to as superalloy welding at elevated temperatures (SWET) have been developed that are performed within an enclosure in which a controlled atmosphere and temperature are maintained to inhibit cracking and oxidation of a superalloy component being welded, as disclosed in U.S. Pat. Nos. 6,020,511, 6,124,568 and 6,297,474. All of these welding processes often use a filler material, which is typically a ductile filler or a filler whose chemistry closely matches that of the base metal being welded. A significant advantage of the latter is that the resulting equiaxed (EA) weld is capable of more nearly matching the properties of the superalloy base metal, including strength and oxidation resistance. Notable weld filler materials of this type include such gamma prime precipitation-strengthened nickel-base superalloys as René 142 and René 195. On the other hand, an advantage of a ductile filler is a reduced tendency for cracking in the weldment. In particular, though an equiaxed precipitation-strengthened nickel-based superalloy weld having a composition similar to that of the base material being welded provides a more nearly optimum weld repair, there is an increased risk for solidification shrinkage, hot tears, and cracking during and after the welding processes, and strain age cracking due to gamma-prime precipitation during post-weld vacuum heat treatment.

Both René 142 and René 195 have been shown to be excellent weld fillers, as evidenced by U.S. Pat. Nos. 6,539,620 and 6,565,680 and U.S. Published Patent Application No. 2003/0145977. These alloys contain significant amounts of rhenium as a solid solution strengthener and a constituent of the strengthening gamma-prime phase. Though effective in these roles, rhenium is a relatively expensive metal. Consequently, weld filler materials that contain lower levels of rhenium would be desirable for welding precipitation-strengthened nickel-base superalloys. However, any such alloy should also be capable of maintaining adequate levels of strength and oxidation resistance while yielding welds that are resistant to cracking.

### BRIEF DESCRIPTION OF THE INVENTION

The present invention provides nickel-base alloys suitable for use as a weld material to weld high-temperature components, such as turbine blades and vanes of gas turbine engines. Welds formed by the alloys are capable of exhibiting desirable levels of strength and oxidation resistance and are resistant to cracking, while the alloy preferably contains little if any rhenium.

According to a first aspect of the invention, a nickel-base alloy consists essentially of, by weight, 5 to 10 percent chromium, 3 to 14 percent cobalt, up to 4 percent molybdenum, 3 to 7 percent tungsten, 5 to 9 percent tantalum, 5 to 8 percent aluminum, 0.1 to 2 percent hafnium, 0.005 to 0.03 percent boron, up to 0.15 percent carbon, the balance being nickel and incidental impurities and/or residual elements.

Other aspects of the invention include processes of using the nickel-base alloys described above to perform a weld operation on a component, and components welded by such processes.

A technical effect of the invention is that the nickel-base alloys are capable of exhibiting levels of strength and oxidation resistance that are required for manufacturing and repairing a wide variety of high-temperature components, including turbine components of gas turbine engines. Welds formed with the alloys are also capable of being resistant to cracking during and after the welding process. The alloys achieve these desirable goals while containing little if any of rhenium, whose presence in nickel-base weld materials is often desirable to promote the strength and oxidation resistance of the weld.

Other aspects and advantages of this invention will be better appreciated from the following detailed description.

### BRIEF DESCRIPTION OF THE DRAWINGS

FIG. 1 represents a cross-section through a turbine component in which a weld has been formed.

FIG. 2 is a bar graph plotting the average time to failure of VPA and PtAl coating on René 142 and Re free René 142 demonstrating that the lack of Re in René 142 does not adversely affect the alloys ability to be environmentally coated.

FIG. 3 is a bar graph plotting the average time to failure of VPA coating on René 195 and Re free René 195 demonstrating that the lack of Re in René 195 does not adversely affect the alloys ability to be environmentally coated.

FIG. 4 is a bar graph plotting rupture life data for René 142 and alloy specimens (T1 and T2) evaluated as weld materials for use with the present invention.

FIG. 5 is a graph plotting oxidation data for specimens formed of René 142, René 195, and alloy specimens (T1, X1 and X2) evaluated as weld materials for use with the present invention.

### DETAILED DESCRIPTION OF THE INVENTION

The present invention provides nickel-base alloys suitable for use as weld materials, and particularly for welding components that are formed of gamma-prime precipitation-strengthened nickel-base superalloys. Notable examples of gamma-prime nickel superalloys include René 125, René 80, René N5, René N4, René 108, GTD-111™, GTD-444TH, IN738, IN792, MAR-M200, MAR-M247, CMSX-3, CMSX-4, PWA1480, PWA1483, and PWA1484, each of which has a relatively high gamma prime content as a result of the significant amounts of aluminum and/or titanium they contain. However, it is foreseeable that the advantages of this invention could be obtained when welding components formed from a variety of materials that are prone to cracking or tearing during manufacture or repair by welding. In addition, the nickel-base alloys are particularly well suited for welding components that are subjected to harsh operating conditions, and particular severe thermal and oxidative environments. Notable but nonlimiting examples include turbine blades (buckets), turbine vanes (nozzles) and other turbine components subjected to the hot gas path of a gas turbine engine, including those used in the aircraft and power generation industries. These components may be formed as directionally-solidified (DS), single-crystal (SX) and equiaxed (EA) castings.

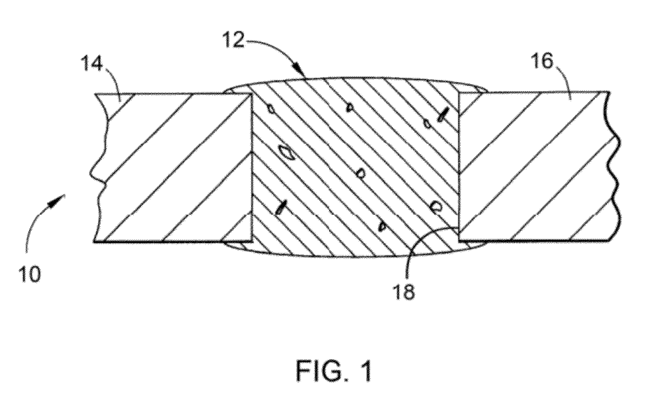

The nickel-base alloys can be employed to repair components, such as by filling cavities or defects in a surface of a component, and can be employed to fabricate components, such as by joining subcomponents together to form a component. FIG. 1 schematically represents a component 10 in which a weld 12 has been formed between two regions 14 and 16 of the component 10. The regions 14 and 16 may be integrally cast portions of the component 10, in which case the weld 12 may serve to fill a cavity or hole 18 in the component 10. Alternatively, the regions 14 and 16 may be two separate cast and/or wrought subcomponents of the component 10, in which case the weld 12 serves to metallurgically joint the regions 14 and 16 together to form the component 10.

Broadly, nickel-base alloys of this invention consist essentially of, by weight, 5 to 10 percent chromium, 3 to 14 percent cobalt, up to 4 percent molybdenum, 3 to 7 percent tungsten, 5 to 9 percent tantalum, 5 to 8 percent aluminum, 0.1 to 2 percent hafnium, 0.005 to 0.03 percent boron, up to 0.15 percent carbon, the balance being nickel and incidental impurities and/or residual elements. In a particular embodiment, a first nickel-base alloy has the following suitable, preferred, and nominal compositions (in weight percent).

TABLE 1A

| | Suitable | Preferred | Nominal |
|---|---|---|---|
| Cr | 5.0-10.0 | 6.0-7.0 | 6.8 |
| Co | 11.0-14.0 | 11-13 | 11.6 |
| Mo | 0.5-4.0 | 1.5-2.5 | 2.0 |
| W | 4.0-7.0 | 6.0-7.0 | 6.5 |
| Ta | 5.0-9.0 | 6.0-7.0 | 6.35 |
| Al | 5.0-7.0 | 5.5-6.5 | 6.1 |
| Hf | 0.3-2.0 | 0.3 to <1.3 | 1.0 |
| Re | <0.1 | <0.01 | 0.0 |
| B | 0.005-0.03 | 0.01-0.02 | 0.015 |
| C | 0.10-0.15 | 0.10-0.15 | 0.12 |
| Ni | Balance | Balance | Balance |

In another particular embodiment, a second nickel-base alloy has the following suitable, preferred, and nominal compositions (in weight percent).

TABLE 1B

| | Suitable | Preferred | Nominal |
|---|---|---|---|
| Cr | 5.0-10.0 | 7.1-7.8 | 7.45 |
| Co | 3.0-14.0 | 3.0-3.3 | 3.15 |
| Mo | ≦4.0 | ≦0.1 | 0.1 |
| W | 3.0-7.0 | 5.1-5.4 | 5.25 |
| Ta | 5.0-9.0 | 5.3-5.6 | 5.5 |
| Al | 5.0-8.0 | 6.4-7.6 | 7.0 |
| Hf | 0.3-2.0 | 0.12-0.18 | 0.13 |
| Re | <0.1 | <0.01 | <0.001 |
| B | 0.005-0.03 | 0.005-0.02 | 0.01 |
| C | 0.1-0.15 | 0.005-0.03 | 0.007 |
| Ni | Balance | Balance | Balance |

The above values allow for the presence of impurities and/or residual elements commonly found in nickel-base alloys, most notably oxygen, nitrogen, sulfur, phosphorus, zirconium and yttrium. For example, sulfur and phosphorous levels are preferably below 5 ppm.

The alloys set forth in Tables 1A and 1B are similar in composition to René 142 and René 195, respectively, with the notable exception that René 142 requires the presence of rhenium in an amount of 1.5 to 4 weight percent and René 195 requires the presence of rhenium in an amount of 1.5 to 1.8 weight percent, whereas the alloys of Tables 1A and 1B do not contain any significant amounts of rhenium, and preferably does not contain any intentional amounts of rhenium. The alloy of Table 1A can also be noted for having nominally higher levels of molybdenum and tungsten and nominally lower levels of hafnium. The higher levels of molybdenum and tungsten were the result of attempts to compensate for the lack of rhenium in the alloy, whereas the reduced levels of hafnium were for the purpose of reducing the tendency for cracking during and after welding. In particular, the preferred levels of hafnium in the alloy are intended to avoid the eutectic reaction between hafnium and nickel that occurs at about 1190° C. when hafnium is present at a level of 1.3 weight percent. The alloy of Table 1B can be noted for containing a nominally higher level of tungsten than René 195 and a nominally lower level of aluminum. The higher level of tungsten compensates for the lack of rhenium in the alloy, whereas the reduced level of aluminum is for the purpose of promoting weldability. The alloys of Tables 1A and 1B have been shown to exhibit properties similar to René 142 and René 195, respectively, and in some cases better than René 142 and René 195. For purposes of fabricating or repairing turbine components, properties of particular interest include mechanical properties including rupture strength, and environmental properties including oxidation resistance.

For the purpose of using the nickel-base alloys as weld materials, the alloys may be formed as weld rods or wires of the types well known and used in various welding methods that use filler materials. Notable examples of such welding techniques include the aforementioned gas tungsten arc welding (GTAW), tungsten inert gas (TIG), plasma transferred arc (PTA), and superalloy welding at elevated temperatures (SWET) welding processes. However, it is foreseeable that the weld filler materials formed of the nickel-base alloys of this invention could be employed in a variety of other welding processes, for example, laser welding processes that use powder filler materials.

In investigations leading up to the present invention, several experimental alloy compositions were investigated to evaluate the possibility of eliminating rhenium from René 142. Two such alloys (T1 and T2) are summarized in Table 2 below. All values are in weight percent.

TABLE 2

| | T1 | T2 |
|---|---|---|
| Cr | 6.62 | 6.72 |
| Co | 11.56 | 11.57 |
| Mo | 1.47 | 1.94 |
| W | 4.91 | 6.46 |
| Ta | 6.47 | 6.45 |
| Al | 6.01 | 5.99 |
| Hf | 1.52 | <0.001 |
| Re | <0.001 | 0.001 |
| Ti | 0.02 | 0.025 |
| B | 0.014 | 0.013 |
| C | 0.12 | 0.12 |
| O | 0.0056 | <0.0019 |
| N | <0.001 | <0.001 |
| Si | 0.006 | 0.006 |
| S | 0.00026 | 0.00029 |
| P | 0.00027 | 0.00021 |
| Zr | 0.007 | 0.006 |
| Y | 0.00003 | 0.000035 |
| Ni | Balance | Balance |

Also tested in the investigations were several experimental alloy compositions formulated to evaluate the possibility of eliminating rhenium from René 195. Two such alloys (X1 and X2) are summarized in Table 3 below. All values are in weight percent.

TABLE 3

| | X1 | X2 |
|---|---|---|
| Cr | 7.46 | 7.46 |
| Co | 3.11 | 3.13 |
| Mo | 0.096 | 0.097 |
| W | 3.89 | 5.26 |
| Ta | 5.43 | 5.53 |
| Al | 7.04 | 7.01 |
| Hf | 0.14 | 0.13 |
| Re | 0.008 | <0.001 |
| Ti | 0.018 | 0.017 |
| B | 0.011 | 0.01 |
| C | 0.011 | 0.0074 |
| O | 0.0029 | 0.0038 |
| N | <0.001 | <0.001 |
| Si | 0.59 | 0.57 |
| S | 0.00017 | 0.00018 |
| P | 0.00018 | 0.00023 |
| Zr | 0.007 | 0.006 |
| Y | 0.000026 | 0.000045 |
| Ni | Balance | Balance |

In contrast to René 195, the experimental alloys set forth in Table 3 do not contain any significant amounts of rhenium. In addition, alloy X2 of Table 3 also contains a nominally higher level of tungsten than René 195 (5.26 weight percent as compared to 3.7 to 4.0 weight percent), and alloys X1 and X2 contain nominally lower levels of aluminum (7.04 and 7.01 weight percent as compared to 7.6 to 8.0 weight percent).

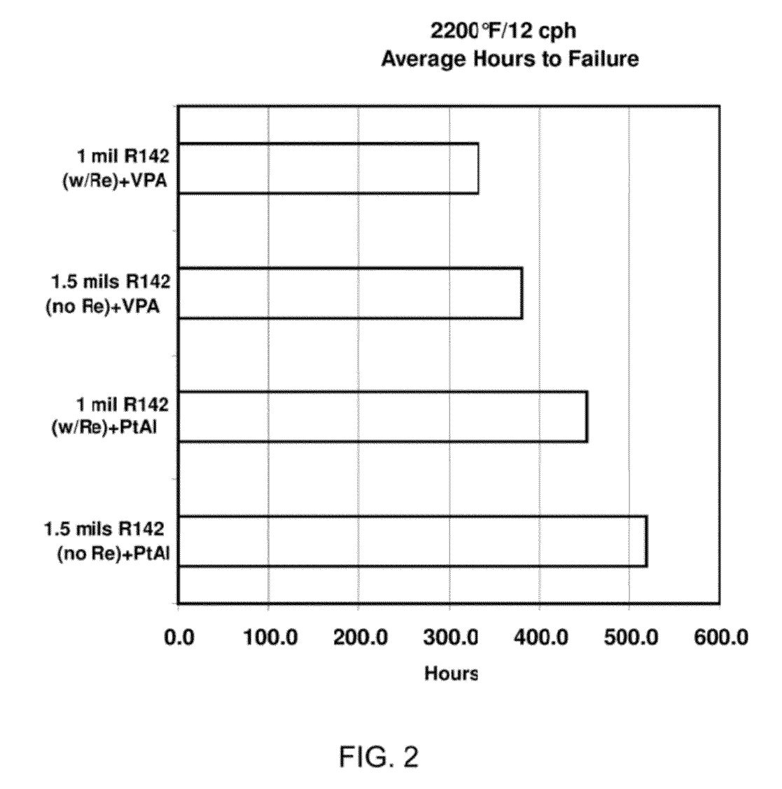

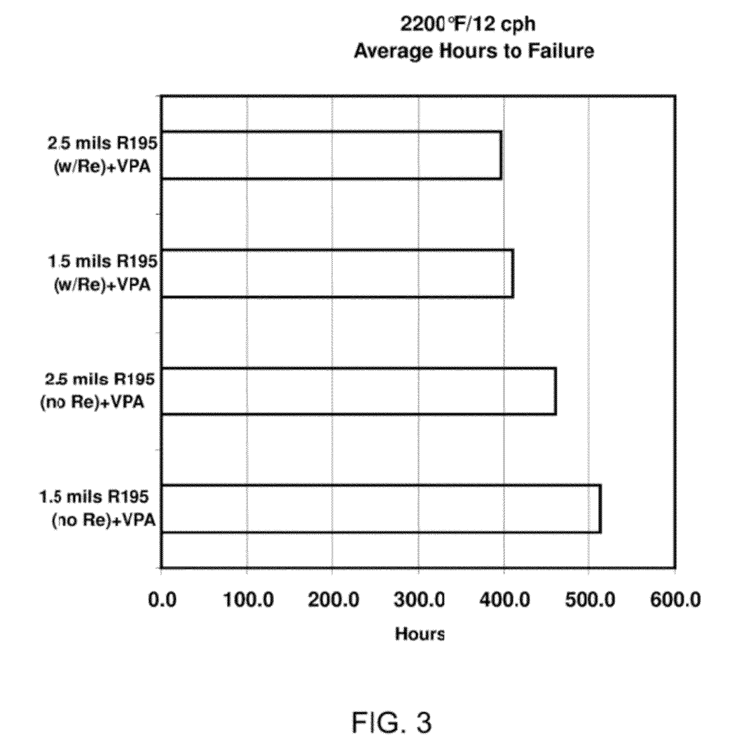

In a first of the investigations, specimens of René 142 and René 195 with and without their nominal rhenium contents underwent a cyclic oxidation study. Specimens of the alloys were coated with either a protective diffusion aluminide coating (VPA) or a protective platinum aluminide diffusion coating (PtAl) to thicknesses of about 1, 1.5 or 2.5 mils (about 25, 38 or 64 micrometers). The specimens were cyclically subjected to a temperature of about 2200° F. (about 1200° C.) at a cycle rate of 12 cycles per hour. Results for the René 142 specimen and the corresponding Re-free specimen are plotted in FIG. 2, and results for the René 195 specimen and the corresponding Re-free specimen are plotted in FIG. 3. The criterion for a failure was penetration of the coating, for example, a pit. The results of these tests evidenced that the specimens lacking rhenium were capable of exhibiting longer oxidation lives than their Re-containing counterparts, René 142 and René 195. Consequently, these results suggested that oxidation-resistant alloys could be formulated based on René 142 and René 195, but without their required rhenium contents.

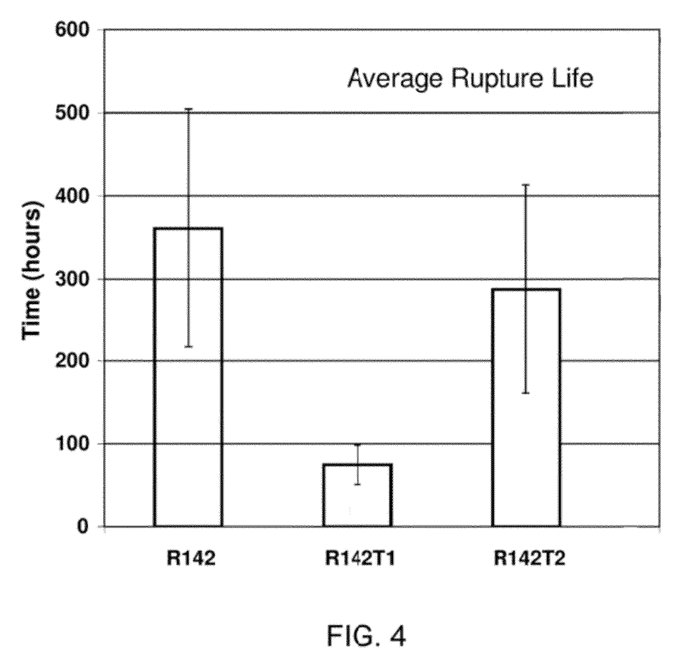

Because rupture strength is an important property of a weld material for use in gas turbine applications, a second investigation was conducted in which three directionally solidified bars of each of René 142 and the experimental alloys T1 and T2 underwent stress rupture testing (ASTM E139). The test was to evaluate the performances of these alloys under short-term high temperature and high stress conditions. The test temperature was about 2000° F. (about 1090° C.) and the stress level was about 10 ksi (about 69 MPa). As previously noted, the T1 and T2 alloys were formulated to contain higher nominal levels of molybdenum and tungsten for the purpose of increasing their strengths to compensate for the absence of rhenium in these experimental alloys. The resulting data are plotted in FIG. 4, which indicates that, on average, the specimens of René 142 outperformed the specimens of alloys T1 and T2. However, the rupture strengths of the T2 specimens were within the statistical range for René 142.

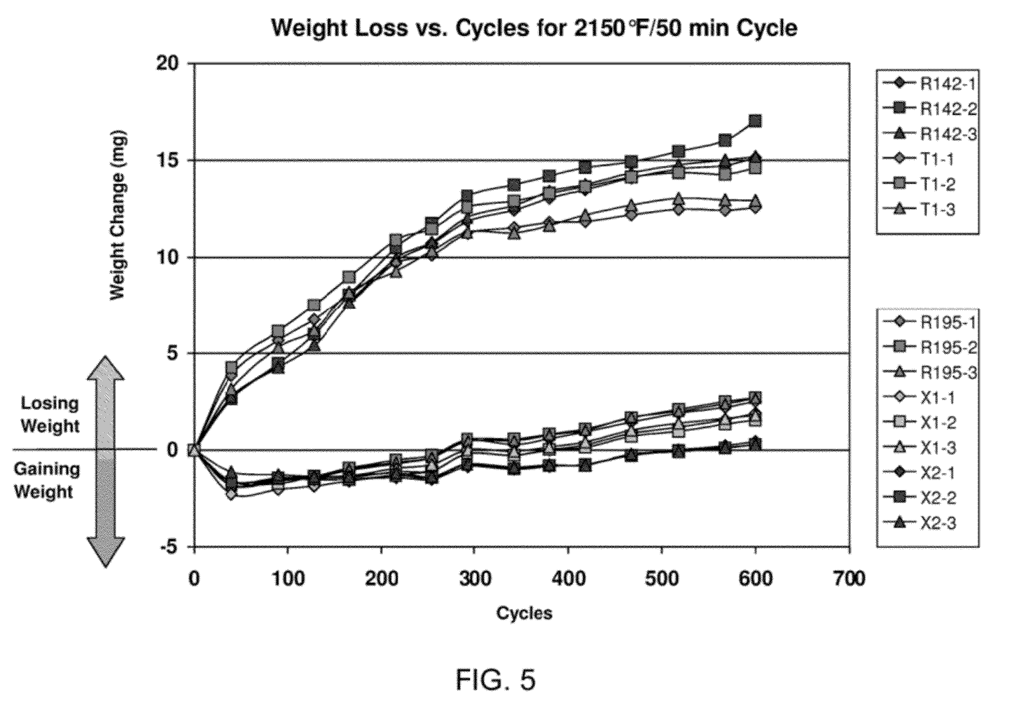

In a third investigation, the oxidation resistance of the experimental alloy T1 and T2 was evaluated along with René 142. Also evaluated were the experimental alloys X1 and X2 of Table 3 and René 195. Three pins of each alloy were subjected to an oxidation study at 2150° F. (about 1180° C.) using 50-minute cycles. Results of the study are shown in FIG. 5, in which cumulative weight change in milligrams is plotted. Weight gains evidence formation of a protective oxide scale (typically a mixture of alumina (Al₂O₃) and chromia (Cr₂O₃)) on the surfaces of the specimens, while weight losses evidence the growth and spallation of an oxide scale. The weight gain curves evidence that René 142 and the experimental T1 alloy both exhibited a slow growth of an oxide scale, and that the T1 alloy exhibited a slightly slower (and therefore better) weight gain. The results of T2 are not plotted in FIG. 5, as its oxidation results were not nearly as good as the other alloys tested. The results of T2 were attributed to the lack of hafnium in this alloy. The René 195 and experimental X1 and X2 specimens exhibited oxidation behavior similar to each other but different than the René 142 and T1 specimens. The René 195 and X1 and X2 specimens initially exhibited a slight weight loss before a gradual weight gain. In addition, the X1 and X2 specimens exhibited slightly slower (and therefore better) weight gains as compared to René 195. The results shown in FIG. 5 suggested that René 142 and the experimental T1 alloy more quickly form an adherent protective oxide scale, but that René 195 and the experimental X1 and X2 alloys also exhibit a steady growth of an adherent protective oxide scale.

From these investigations, it was concluded that the Re-free alloys T1, X1 and X2 are viable candidates for replacing René 142 and René 195 as weld materials for gas turbine applications, as well as other high temperature applications in which both strength and oxidation resistance are desirable properties. It was further concluded that increasing the hafnium content of alloy T2 could result in this alloy being a viable candidate for replacing René 142. Notably, these properties are achieved without any intentional or significant additions of rhenium, which is an important solid solution and precipitation phase strengthener in both René 142 and René 195. As such, the Re-free alloys disclosed herein are capable of being produced and used at a lower cost than René 142 and René 195.

While the invention has been described in terms of a preferred embodiment, it is apparent that other forms could be adopted by one skilled in the art. Therefore, the scope of the invention is to be limited only by the following claims.

1. A nickel-base alloy for use as weld material, the nickel-base alloy consisting essentially of, by weight:
5 to 10 percent chromium;
3 to 14 percent cobalt;
up to 4 percent molybdenum;
3 to 7 percent tungsten;
5 to 9 percent tantalum;
5 to 8 percent aluminum;
0.1 to 2 percent hafnium;
0.005 to 0.03 percent boron;
up to 0.15 percent carbon;
the balance being nickel and incidental impurities and residual elements.

2. The nickel-base alloy according to claim 1, wherein the nickel-base alloy contains 11 to 14 weight percent cobalt, 4.0 to 7.0 weight percent tungsten, and 5.0 to 7.0 weight percent aluminum.

3. The nickel-base alloy according to claim 1, wherein the nickel-base alloy contains 1.5 to 2.5 weight percent molybdenum, 6.0 to 7.0 weight percent tungsten, and less than 1.3 weight percent hafnium.

4. The nickel-base alloy according to claim 1, wherein the nickel-base alloy contains 5.1 to 5.4 weight percent tungsten and 6.4 to 7.6 weight percent aluminum.

5. The nickel-base alloy according to claim 1, wherein the nickel-base alloy consists essentially of, by weight, about 6.8 percent chromium, about 11.6 percent cobalt, about 2.0 percent molybdenum, about 6.5 percent tungsten, about 6.35 percent tantalum, about 6.1 percent aluminum, about 1.0 percent hafnium, about 0.015 percent boron, about 0.12 percent carbon, and the balance being nickel and incidental impurities and residual elements.

6. The nickel-base alloy according to claim 1, wherein the nickel-base alloy consists essentially of, by weight, about 7.4 percent chromium, about 3.1 percent cobalt, about 0.1 percent molybdenum, about 5.25 percent tungsten, about 5.5 percent tantalum, about 7.0 percent aluminum, about 0.13 percent hafnium, about 0.01 percent boron, about 0.007 percent carbon, and the balance being nickel and incidental impurities and residual elements.

7. The nickel-base alloy according to claim 1, wherein the nickel-base alloy is in the form of a weld (12) on a turbine component (10) of a gas turbine engine.

8. The nickel-base alloy according to claim 7, wherein the turbine component (10) is formed of a gamma-prime precipitation-strengthened nickel-base superalloy.

9. The nickel-base alloy according to claim 8, wherein the turbine component (10) is a turbine blade or turbine nozzle.

10. A process of using the nickel-base alloy according to claim 1 to weld a component (10), the process comprising welding the component by melting and depositing the nickel-base alloy on the component to form a weld (12) on the component.

11. The process according to claim 10, wherein the weld (12) repairs a flaw (18) in the component (10).

12. The process according to claim 10, wherein the weld (12) joins at least two subcomponents (14,16) to form the component (10).

13. A process of welding a component (10), the process comprising melting and depositing a nickel-base alloy on the component (10) to form a weld (12) on the component (10), the nickel-base alloy consisting essentially of, by weight:
5 to 10 percent chromium;
3 to 14 percent cobalt;
up to 4 percent molybdenum;
3 to 7 percent tungsten;
5 to 9 percent tantalum;
5 to 8 percent aluminum;
0.1 to 2 percent hafnium;
0.005 to 0.03 percent boron;
up to 0.15 percent carbon;
the balance being nickel and incidental impurities and residual elements.

14. The process according to claim 13, wherein the nickel-base alloy contains 1.5 to 2.5 weight percent molybdenum, 6.0 to 7.0 weight percent tungsten, and less than 1.3 weight percent hafnium.

15. The process according to claim 13, wherein the nickel-base alloy contains 5.1 to 5.4 weight percent tungsten and 6.4 to 7.6 weight percent aluminum.

16. The process according to claim 13, wherein the component is a turbine component (10) of a gas turbine engine.

17. The process according to claim 16, wherein the turbine component (10) is formed of a gamma-prime precipitation-strengthened nickel-base superalloy.

18. The process according to claim 16, wherein the weld (12) repairs a flaw (18) in the turbine component (10).

19. The process according to claim 16, wherein the weld (12) joins at least two subcomponents (14,16) to form the turbine component (10).

20. The turbine component (10) welded by the process of claim 16.
